(19) United States
(12) Patent Application Publication
(10) Pub. No.: US 2006/0085306 A1
(43) Pub. Date: Apr. 20, 2006

(54) Integrated virtual tax auditing system

(75) Inventors: Robert Schulte, San Diego, CA (US); Marc Staheli, San Diego, CA (US)

Correspondence Address: PETER K HAHN;LUCE, FORWARD, HAMILTON, SCRIPPS, LLP., 600 WEST BROADWAY, SUITE 2600, SAN DIEGO, CA, 92101, US

(73) Assignee: vAudit Group, San Diego, CA (US)

(21) Appl. No.: 10/955,371

(22) Filed: Sep. 29, 2004

(51) Int. Cl. G06F 17/22; G07F 19/00

(52) U.S. Cl. 705/31

(57) ABSTRACT

An integrated virtual tax auditing system for performing tax compliance functions for organizations having tax reporting requirements comprises a system database, an information assistant for extracting data from one or more client databases and inputting the data into the system database and a compliance auditor for performing a virtual audit of transactions for a selected tax.

### FIELD OF THE INVENTION

The present invention generally relates to tax auditing systems, and more particularly, to an integrated virtual tax auditing system.

### BACKGROUND OF THE INVENTION

Many known software products provide tax compliance systems. Such tax compliance systems typically provide tax calculation tools, tax reporting tools or tax documentation tools. While most of these software products include only stand-alone tools, some products provide the ability to integrate a plurality of tools as long as they are from the same vendor or have a vendor specific interface.

Conventional tax compliance software products that provide tax calculation and tax reporting tools suffer from the following drawbacks. One drawback of such software products is that they are not automated, and may drain organizational resources due to the presence of innumerable manual processes. Additionally, most of these products are platform driven, thereby requiring a specific implementation of the software. Furthermore, no conventional tax compliance products actually audit transactions or produce a compliance exception report detailing areas of non-compliance exposure.

Accordingly, there exists a need for an integrated virtual tax auditing system that is an automated system that provides integrated components for audit analysis, tax calculation, tax reporting and tax compliance documentation.

### SUMMARY OF THE INVENTION

The present invention provides an integrated virtual tax auditing system that provides a tax calculation and reporting tool, and also performs an analysis that actually audits the transactions to ensure compliance. In a preferred implementation, integrated virtual tax auditing system is used to comply with the sales, use and transactions tax (SUTT). According to other embodiments of the invention, the integrated virtual tax auditing system is used to comply with other taxes such as utility taxes, telecom taxes, property taxes, timber taxes, value added taxes and other taxes.

One aspect of the invention involves an integrated virtual tax auditing system for performing tax compliance functions comprising a system database, an information assistant for extracting data from one or more client databases and loading the data into the system database, a system controller for tracking and passing information between the integrated modules, an exemption certificate manager providing web-deployed tools for exemption certificate administration and a compliance auditor for performing a virtual audit of the transactions for a selected tax. The system controller preferably cleanses the client data and then serves as a direct link to the other system components.

According to a preferred implementation, the information assistant comprises client site software that serves as an information hub by controlling the flow of information from the outside entity to the integrated tax auditing system. The information assistant further provides automatic tax rate updates and advises clients of major legislative changes in their respective operating industry. Preferably, the information assistant is a platform independent tool capable of executing dynamic scripts from the integrated auditing system central database. In operation, the information assistant feeds the controller, whereas the controller feeds all the modules.

According to a further aspect of the invention, the exemption certificate manager comprises an exemption certificate engine and a web hosted application for accessing exemption certificates via the Internet. Additionally, the exemption certificate manager automatically sends a link to the web application to authorized clients. According to a preferred embodiment, the exemption certificate manager identifies exempt transactions, determines missing exemption certificates by running a query, and automatically communicates a request for certificate information from the exempt customer. The exemption certificate manager also sends warnings such as automated communication alerts to appropriate authorized clients when errors are determined or certificates are deemed to be missing.

According to an additional aspect of the invention, the compliance auditor analyzes the transactions and produces exception and error reports indicating the level of compliance and identifying specific areas of non-compliance. The compliance auditor preferably has the ability to identify non-compliant and potentially non-compliant transactions prior to the tax compliance filing deadline or on a nearly real-time basis. Advantageously, the compliance auditor analyzes and audits all transactions rather than a sampling of transactions.

According to another aspect of the invention, the integrated virtual tax auditing system further comprises a tax return generator comprising a web hosted application that is scalable by taxing jurisdiction. In other words, an organization only has to buy subscriptions to appropriate modules for those taxing jurisdictions with which the organization has a sufficient nexus. The tax return generator imports relevant tax transaction data and automatically generates tax returns for all required state and provincial governments. Further, the tax return editor archives client tax returns from previous filing periods such that the tax returns are accessible to authorized clients.

According to a further aspect of the invention, the integrated virtual tax auditing system further comprises an internal document manager that tracks all document communication between the client and the integrated tax auditing system. Advantageously, the internal document manager creates a comprehensive audit trail by tracking communications among all integrated virtual tax auditing system components and the client.

According to additional embodiments of the present invention, the integrated virtual tax auditing system further comprises an audit source manager, report generators and a corrective action manager. The audit source manager preferably utilizes information received from the internal document manager to track all aspects of state agency audit history for each client organization. The report generator communicates with all other components of the integrated tax auditing system and creates reports for authorized clients and system users, whereas the corrective action manager comprises a web-deployed client interface that interacts with authorized clients and system users to take corrective action in response to a virtual audit.

### BRIEF DESCRIPTION OF THE DRAWINGS

FIG. 1 is a diagram depicting the integrated virtual tax auditing system of the present invention;

FIG. 2 is a diagram depicting the information assistant of the integrated virtual tax auditing system of the present invention;

FIG. 3 is a diagram depicting the exemption certificate manager of the integrated virtual tax auditing system of the present invention;

FIG. 4 is another diagram depicting the exemption certificate manager of the integrated virtual tax auditing system of the present invention;

FIG. 5 is a diagram depicting the compliance auditor of the integrated virtual tax auditing system of the present invention; and

FIG. 6 is a diagram depicting the tax return generator of the integrated virtual tax auditing system of the present invention.

It will be recognized that some or all of the Figures are schematic representations for purposes of illustration and do not necessarily depict the actual relative sizes or locations of the elements shown.

### DETAILED DESCRIPTION OF THE INVENTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

In accordance with the principles of the present invention, an integrated virtual tax auditing system is provided for performing the compliance function of various taxes such as the sales, use and transactions tax (SUTT). According to other embodiments of the invention, the integrated virtual tax auditing system may be used to comply with other taxes such as utilities taxes, telecom taxes, property taxes, timber taxes, value added taxes and other taxes. The system preferably is implemented as part of a computer system including a software program comprising machine readable or interpretable instructions for providing a virtual audit analysis of applicable transactions including, but not limited to: (1) compliance analysis; (2) purchase order and contract analysis; (3) exemption certificate analysis; (4) tax analysis; (5) dual payment analysis; (6) nexus analysis; and (7) audit trail documentation.

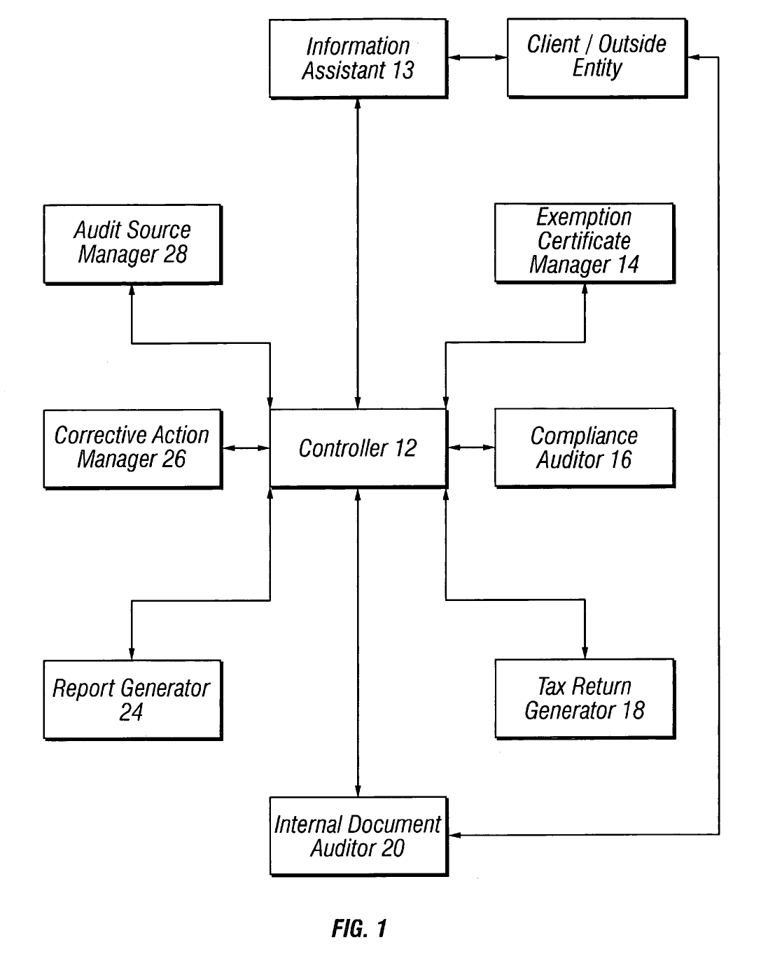

Referring to FIG. 1, integrated virtual tax auditing system 10 performs tax compliance functions for organizations having tax reporting requirements. The system 10 comprises a plurality of components or modules that preferably are integrated into a single comprehensive SUTT-compliant product for applicable transactions. The components include controller 12, information assistant 13, exemption certificate manager 14, compliance auditor 16, tax return generator 18, internal document auditor 20, report generator 24, corrective action manager 26 and audit source manager 28. Although preferred embodiments of the invention are configured to provide an integrated tax auditing system for complying with the SUTT, it will be apparent to those of ordinary skill in the art that the system may be applied to various other taxes (e.g., utilities, telecom, property, timber, value added and other taxes), without departing from the scope of the present invention.

Integrated virtual tax auditing system 10 utilizes the software program to extract client data, encrypt the data, and then transmit the data over a secure network. The virtual auditing system also loads the encrypted data into a proprietary compliance database. Information assistant 13 is the data extraction and client maintenance module of the integrated system of the present invention feeding the client information to the controller 12, whereas compliance auditor 16 performs the necessary analysis and provides the results to the other system components.

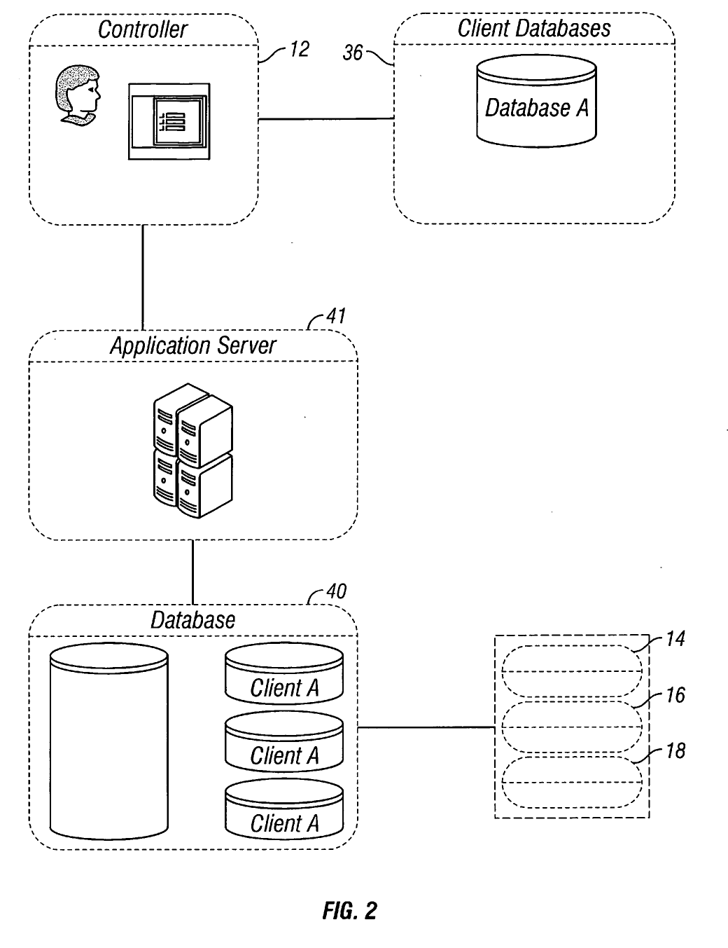

Referring to FIG. 2, information assistant 13 comprises client site software that controls the flow of information to and from the integrated system of the present invention. A system user 34 may utilize information assistant 13 to extract data from one or more client databases 36 and transfer the data to integrated system database 40 via application server 41. System database 40 stores client information (i.e., for Client A, Client B, Client C, etc.) that may be accessed by authorized users via a web portal. In this manner, information assistant 13 provides pertinent data for all components of integrated auditing system 10, including controller 12, exemption certificate manager 14, compliance auditor 16 tax return generator 18, corrective action manager 26, and audit source manager 28.

Controller 12 preferably cleanses client data and serves as a direct link to the other system components. Controller 12 communicates with outside entities via information assistant 13. Information assistant 13 preferably provides automatic tax rate updates that ensures the client's organization is operating with the most current tax rates and forms. Additionally, information assistant 13 advises clients of major legislative changes in their respective operating industry. Information assistant 13 retrieves software maintenance updates for system components and communications via web services. Advantageously, information assistant 13 provides the data for all web hosted applications in a single package. According to a preferred implementation, information assistant 13 is a platform independent tool capable of executing dynamic scripts. In operation, the information assistant feeds the controller, whereas the controller feeds all the modules.

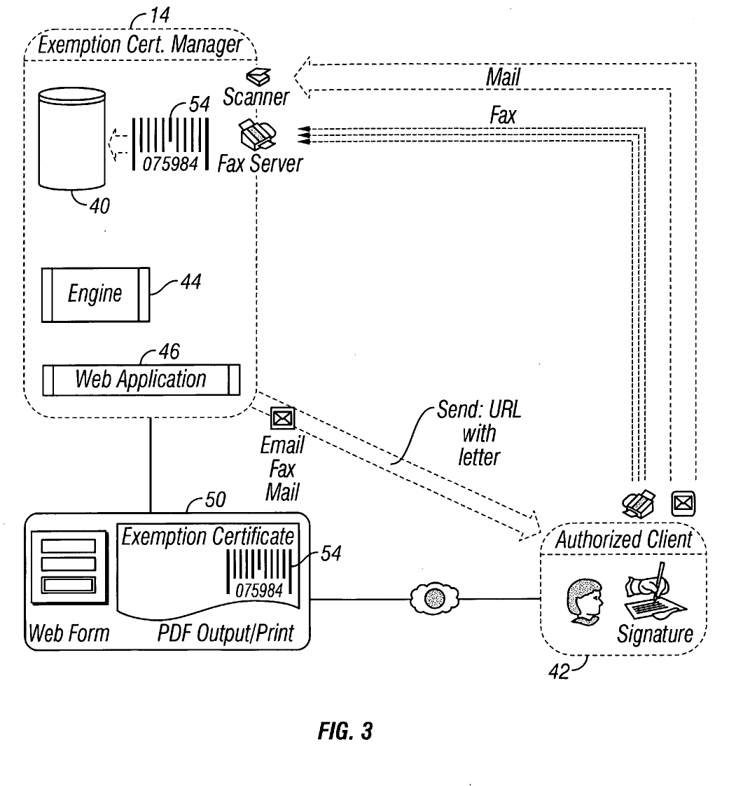

Referring to FIG. 3, exemption certificate manager 14 offers advanced web-deployed tools for exemption certificate management and administration. According to a preferred embodiment, exemption certificate manager 14 comprises exemption certificate engine 44 and web hosted application 46. Authorized clients 42 may access exemption certificates 50 via web application 46 using the Internet. Alternatively, the exemption certificate manager (or any other system component of the invention) may comprise a standalone software program that may be accessed using a LAN, WAN or other public or private telecommunications network. Exemption certificate manager 14 preferably automatically e-mails a URL link to the web application to authorized clients, along with a unique access code. Authorized clients 42 may include client organizations and approved agents of client organizations. Exemption certificate manager 14 may alternatively automatically send the appropriate URL information by other suitable forms of delivery, such as by facsimile or by standard mail.

Upon receiving the URL link, authorized client 42 is prompted to log in to the corresponding website using the access code and fill out exemption certificate 50, which preferably includes a machine readable identifier such as barcode 54. More particularly, the integrated virtual tax auditing system preferably utilizes advanced bar coding technology, which reduces client input error during the indexing process. Exemption certificate manager 14 then validates the information entered by authorized client 42 against the corresponding information in database 40. Once the information has been validated, exemption certificate manager 14 prompts the client to print and sign exemption certificate 50, and then send the executed certificate to a predetermined address (e.g., via fax), such that exemption certificate 50 can be loaded into database 40. When exemption certificate 50 is received, barcode 48 is scanned using a suitable scanner and the certificate is loaded into database 40 using conventional barcode indexing.

Advantageously, exemption certificate manager 14 provides the benefit of an outsourced solution while retaining instant accessibility to crucial exemption certificate documentation on-site. According to a preferred implementation of the present invention, exemption certificate manager 14 automatically keeps track of previously entered data and determines when certificates are missing. More particularly, exemption certificate manager 14 determines missing exemption certificates by running a conventional query. The exemption certificate manager automatically identifies missing certificates, creates the request and transmits them to appropriate exempt clients. Exemption certificate manager 14 preferably sends warnings such as e-mail alerts to appropriate authorized clients when errors are determined or certificates are missing. Additionally, exemption certificate manager 14 may send exemption certificate reports to appropriate authorized clients and system users.

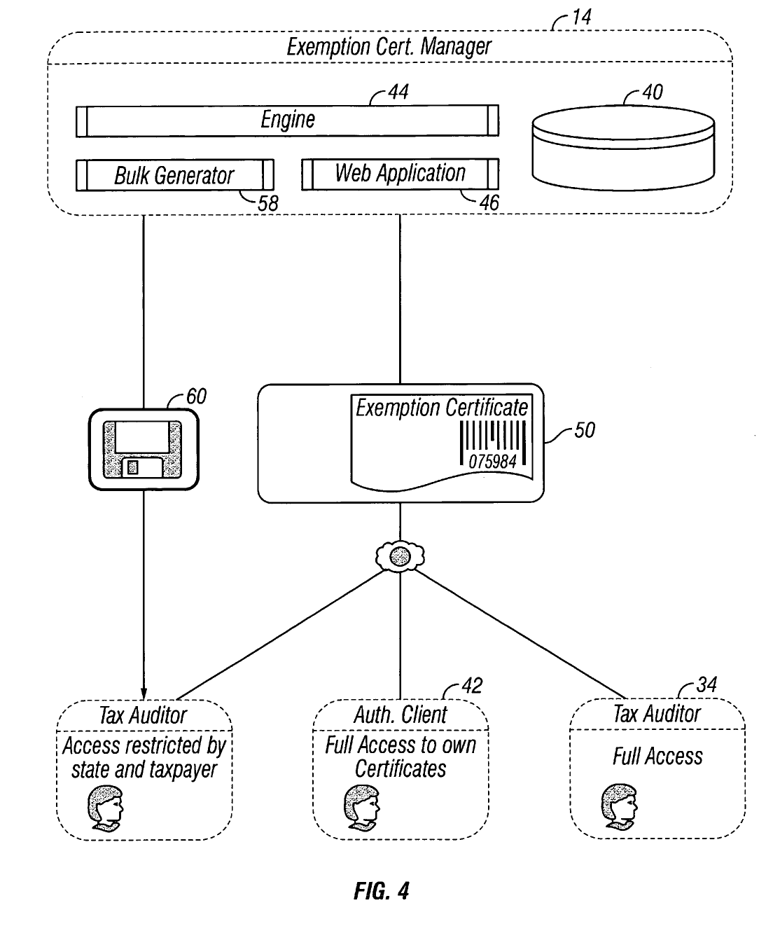

Referring to FIG. 4, according to a preferred implementation of the present invention, exemption certificate manager 14 further comprises bulk generator 58. Bulk generator 58 preferably is configured to save certificates onto a transferable medium 60 such as compact disks. As would be appreciated by those of ordinary skill in the art, many other forms of transferable medium may be employed (e.g., floppy disks) without departing from the scope of the present invention. Also, certificate and supporting information can be downloaded or accessed from the Internet application server. Authorized tax auditors 62 that request certificates in bulk are provided with transferable medium 60 containing the requested certificates or they can access certificates in bulk using Internet.

Exemption certificates 50 preferably are available to selected users with varying degrees of authorization. In the illustrated embodiment, system users 34 have full access to all exemption certificates 50, whereas authorized clients 42 only have full access to their own certificates and access by tax auditors is restricted by state and taxpayer. Exemption certificate manager tracks the expiration date of certificates and sends renewal notices.

The exemption certificate manager of the present invention provides numerous advantages over conventional certificate managers including automation of a previously manual indexing function. Additionally, the exemption certificate manager 14 provides exemption certificates that are web deployed and accessible from any location through secure site access. Exemption certificate manager 14 also tracks and updates legislative revisions to exemption certificates and provides jurisdiction specific access to state auditors via the Internet. Moreover, the exemption certificate manager significantly reduces the cost of exemption certificate management, and can reduce the dollar amount of audit liability by approximately 26% in SUTT audits.

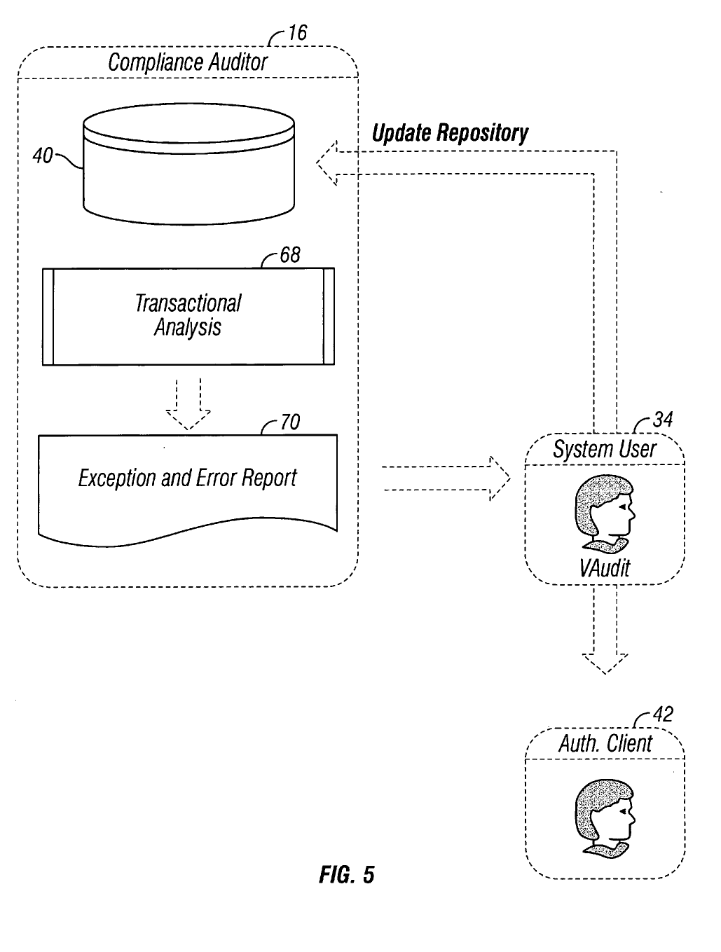

Referring to FIG. 5, compliance auditor 16 is a web hosted application that performs a virtual audit of transactions for a selected tax. Compliance auditor 16 analyzes the transactions (transaction analysis 68) and provides exception and error reports 70 (e.g., spreadsheet-based reports) indicating the level of compliance and identifying specific areas of non-compliance. According a preferred embodiment of the invention, a URL link to a compliance questionnaire is automatically sent to clients along with details of potentially non-compliant transactions and/or a request for additional information. Exception and error reports 70 may be reviewed by a system user 34 such as a field auditor. According to some embodiments, appropriate authorized clients 42 are automatically provided with a corrective measures checklist.

The compliance auditor of the present invention provides numerous advantages including the ability to identify non-compliant and potentially non-compliant transactions prior to the tax return being filed. In addition, compliance auditor 16 analyzes and audits every transaction as opposed to merely using some form of sampling. Compliance auditor 16 further provides an in-depth analysis of sales and purchasing transactions and identifies favorable regulatory exemptions applicable to these transactions. Some additional advantages of the compliance auditor include, but are not limited to: (1) providing the ability to reduce tax liability due to excess tax accruals, dual payments, and incorrect accruals on exempt transactions; (2) providing the ability to reduce exposure to tax audit liability; and (3) providing the ability to reduce penalty and interest in tax audits.

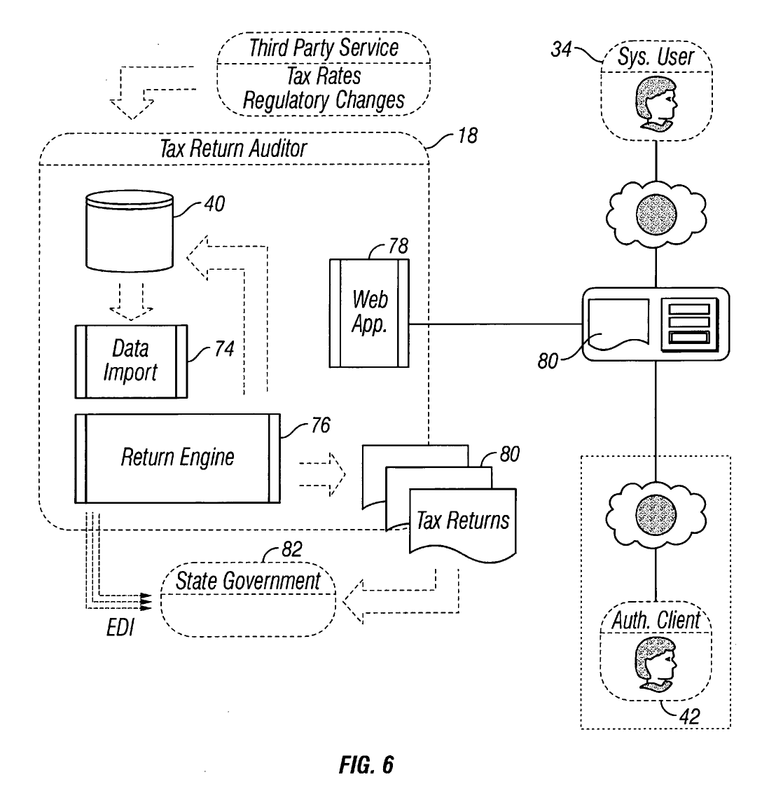

Referring to FIG. 6, tax return generator 18 is a web hosted application that allows an organization to file its tax returns in all the taxing jurisdictions of the United States and Canada. Organizations, such as corporations, must pay taxes in all states with which the organization has a sufficient nexus. Larger organizations that have multiple business locations must pre-pay taxes to a plurality of jurisdictions on a monthly basis in addition to the quarterly reporting process. According to a preferred embodiment, the tax return generator is scalable by taxing jurisdiction such that an organization only has to buy appropriate subscriptions for those taxing jurisdictions with which the organization has a sufficient nexus. Additionally, tax return generator 18 allows an organization to add or subtract jurisdictional filing requirements, and also obviates the need for costly tax software implementations, license fees, and maintenance.

With further reference to FIG. 6, tax return generator 18 comprises data import 74, return engine 76 and web hosted application 78. In operation, data import 74 imports relevant tax transaction data and return engine 76 automatically generates tax returns 80 for all required state or provincial governments 82. Tax return generator 18 includes an Electronic Data Interchange (EDI) for electronic tax filings as well as conventional paper based filing capabilities. Tax returns 80 from previous filing periods are available to system users 34 and authorized clients 42 by accessing web application 78, for example via the Internet.

Tax return generator 18 preferably is periodically updated with tax rate, tax form, and regulatory changes, for example using third party service 86. Machine readable identifiers such as barcodes may be embedded on selected tax returns as required by state agencies. All tax returns 80, related transactions and detail data are archived in database 40. Tax return generator 18 preferably sends warnings such as e-mail alerts to appropriate clients to notify interested parties of upcoming deadlines and whether various predetermined conditions are present.

In accordance with another aspect of the present invention, audit source manager 28 is an integrated module that tracks and maintains all document communication through integrated virtual tax auditing system 10. More particularly, audit source manager 28 creates a comprehensive audit trail by tracking communications between: (1) integrated virtual tax auditing system components 12, 14, 16, 18, 20, 24, 26; (2) system users 34; (3) authorized clients; (4) web deployed interfaces; (5) inquiry forms; and (5) all document generations (PDF, DOC, XLS, etc).

In accordance with an additional aspect of the present invention, audit source manager 28 utilizes information received from system components 12, 14, 16, 18, 20, 24, as well as manually input data, to track all aspects of state agency audit history for each client organization. Some aspects of state agency audit history that are tracked by audit source manager 28 include, but are not limited to: (1) audit results; (2) areas of non-compliance; (3) department responsible for compliance; (4) dollar amounts; (5) audit period; (6) auditors assigned to the case; (7) state, county, city, or local agency with jurisdiction; (8) projected future audit date; (9) communication log between entities (cost centers, department, agencies, etc); (10) task list; and (11) concurred and non-concurred items.

In accordance with a further aspect of the present invention, report generator 24 queries the other components of integrated virtual tax auditing system 10, and creates reports for system users 34, authorized clients 42, client organizations, auditors, state agencies, and other interested parties. The reports preferably may be web-deployed in any format, as well as mass produced on other media, for example, for the purposes of audit defense or the development of internal controls.

In accordance with another aspect of the present invention, corrective action manager 26 comprises a web-deployed client interface that interacts with authorized clients 42 and system users 34 to take corrective action. The results of a virtual audit analysis conducted by compliance auditor 16 are used to generate a questionnaire that specifically addresses areas of non-compliance and potentially non-compliance exposure. For example, in the instance of a purchase from an out-of-state vendor, the compliance auditor module may require more information to determine if a particular transaction is subject to taxation. The required information is gathered through the automatic deployment of a URL linked questionnaire to authorized clients 42 within the subject organization. Authorized clients 42 preferably are only required to check a box or utilize a drop down menu to provide the necessary answer. Authorized clients 42 are then prompted to describe the source documentation used to answer the inquiry and transmit the results to the integrated auditing system so that corrective action is automatically taken.

Thus, it is seen that an integrated virtual tax auditing system is provided. One skilled in the art will appreciate that the present invention can be practiced by other than the above-described embodiments, which are presented in this description for purposes of illustration and not of limitation. The description and examples set forth in this specification and associated drawings only set forth preferred embodiment(s) of the present invention. The specification and drawings are not intended to limit the exclusionary scope of this patent document. It is noted that various equivalents for the particular embodiments discussed in this description may practice the invention as well.

What is claimed is:

1. An integrated tax auditing system for performing tax compliance functions for organizations having tax reporting requirements, the system comprising:
a system database;
an information assistant for extracting data from one or more client databases and inputting the data into the system database; and
a compliance auditor for performing a virtual audit of transactions for a selected tax.

2. The system of claim 1, wherein the information assistant comprises client site software that serves as an information hub by controlling the flow of information from the client to the integrated tax auditing system.

3. The system of claim 1, wherein the system database stores client information that is accessible by authorized clients via a web portal.

4. The system of claim 1, wherein the information assistant provides automatic tax rate updates and advises clients of major legislative changes in their respective operating industry.

5. The system of claim 1, wherein the information assistant is a platform independent tool capable of executing dynamic scripts.

6. The system of claim 1, further comprising an exemption certificate manager providing web-deployed tools for exemption certificate management and administration;
wherein the exemption certificate manager comprises an exemption certificate engine and a web hosted application for accessing exemption certificates via the Internet.

7. The system of claim 6, wherein the exemption certificate manager automatically sends a link to the web application to authorized clients.

8. The system of claim 6, wherein each exemption certificate includes a unique machine readable identifier.

9. The system of claim 6, wherein the exemption certificate manager determines missing exemption certificates by running a query, automatically creates missing certificates, and transmits the certificates to appropriate clients.

10. The system of claim 6, wherein the exemption certificate manager sends warnings to appropriate authorized clients when errors are determined or certificates are deemed to be missing.

11. The system of claim 1, wherein the compliance auditor analyzes the transactions and produces exception and error reports indicating the level of compliance and identifying specific areas of non-compliance.

12. The system of claim 1, wherein the compliance auditor has the ability to identify non-compliant and potentially non-compliant transactions prior to the jurisdictional filing deadline and in nearly real time.

13. The system of claim 1, wherein the compliance auditor analyzes and audits all transactions rather than a sampling.

14. The system of claim 1, wherein the system is adapted to comply with the sales, use and transactions tax.

15. The system of claim 1, wherein the system is adapted to comply with a tax selected from the group consisting of utilities, telecom, property, timber, and value added taxes.

16. The system of claim 1, further comprising a tax return generator.

17. The system of claim 16, wherein the tax return generator is a web hosted application that is scalable by taxing jurisdiction.

18. The system of claim 16, wherein the tax return generator imports relevant tax transaction data and automatically generates tax returns for all required state and provincial governments.

19. The system of claim 16, wherein the tax return editor archives client tax returns from previous filing periods such that the tax returns are accessible to authorized clients.

20. The system of claim 1, further comprising an internal document auditor.

21. The system of claim 20, wherein the internal document auditor tracks all document communication between outside entities and the integrated tax auditing system.

22. The system of claim 21, wherein the internal document auditor creates a comprehensive audit trail by tracking communications between integrated virtual tax auditing system components and outside entities

23. The system of claim 20, further comprising an audit source manager.

24. The system of claim 23, wherein the audit source manager utilizes information received from the internal document auditor to track all aspects of state agency audit history for each client organization.

25. The system of claim 1, further comprising a report generator.

26. The system of claim 25, wherein the report generator queries all other components of the integrated tax auditing system, and creates reports for authorized clients and system users.

27. The system of claim 1, further comprising a corrective action manager.

28. The system of claim 27, wherein the corrective action manager comprises a web-deployed client interface that interacts with authorized clients and system users to take corrective action in response to a virtual audit.
